(19) United States
(12) Patent Application Publication
(10) Pub. No.: US 2021/0234301 A1
(43) Pub. Date: Jul. 29, 2021

(54) CONDUCTION PATH AND CONNECTOR DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kazunori Ito, Yokkaichi-shi, Mie (JP)

(21) Appl. No.: 16/972,337

(22) PCT Filed: May 17, 2019
(86) PCT No.: PCT/JP2019/019698

§ 371 Date: Dec. 4, 2020

(30) Foreign Application Priority Data
Jun. 7, 2018 (JP) 2018-109377

(51) Int. Cl. H01R 13/59; H01R 13/58; H01R 13/6463

(52) U.S. Cl. CPC H01R 13/59; H01R 13/6463; H01R 13/58

(57) ABSTRACT

A conduction path includes a housing, a twisted wire pair that is obtained by twisting together a pair of coated wires, a pair of terminal fittings that are individually fixed to front end portions of the pair of coated wires and are inserted into the housing from behind, and a wire holder that is separate from the housing and holds the twisted wire pair such that the twisted wire pair can move together with the wire holder, wherein the wire holder can move close to the housing in an axial direction and move in a circumferential direction relative to the housing. When the wire holder holding the twisted wire pair is moved close to the housing in the axial direction and moved in the circumferential direction relative to the housing, untwisted regions of the coated wires are twisted and return to the twisted state.

### CROSS-REFERENCE TO RELATED APPLICATIONS

This application is the U.S. national stage of PCT/JP2019/019698 filed on May 17, 2019, which claims priority of Japanese Patent Application No. JP 2018-109377 filed on Jun. 7, 2018, the contents of which are incorporated herein.

### TECHNICAL FIELD

The present disclosure relates to a conduction path and a connector device.

### BACKGROUND

In differential signal transmission, a twisted wire pair that is obtained by twisting together two wires is used as a communication line. A connector disclosed in Patent Document 1 includes a twisted wire pair, terminal portions that are connected to end portions of a pair of wires constituting the twisted wire pair, and a connector main body that houses the pair of terminal portions. The wires are untwisted in an end portion of the twisted wire pair to connect the terminal portions. The terminal portions are inserted into the connector main body from behind. At this time, if the pair of terminal portions are inserted at the same time, the terminal portions may be improperly inserted, and therefore it is preferable to separately insert the two terminal portions into the connector main body.

In the case of the above-described connector, after one of the terminal portions is inserted into the connector main body, the other terminal portion needs to be moved to the rear side of the connector main body. Accordingly, the wires need to be untwisted at least over a length that is equivalent to the entire length of the terminal portions. However, if the wires are untwisted over a long length, communication performance may be deteriorated, and therefore it is desirable to take measures against this.

The present disclosure was completed based on the above circumstances, and an object of the present disclosure is to improve communication performance of a twisted wire pair.

### SUMMARY

A conduction path of a first embodiment includes a housing and a twisted wire pair that is obtained by twisting together a pair of wires. A pair of terminal fittings are individually fixed to front end portions of the pair of wires and are inserted into the housing from behind. A wire holder is separate from the housing and holds the twisted wire pair such that the twisted wire pair can move together with the wire holder, wherein the wire holder can move close to the housing in an axial direction and move in a circumferential direction relative to the housing.

A connector device of a second embodiment includes a housing and a pair of terminal fittings that are configured to be individually fixed to front end portions of a pair of wires constituting a twisted wire pair and are inserted into the housing from behind. A wire holder is separate from the housing and is configured to hold the twisted wire pair such that the twisted wire pair can move together with the wire holder, wherein the wire holder can move close to the housing in an axial direction and move in a circumferential direction relative to the housing.

The present disclosure may also include a guide portion that is configured to make the wire holder move close to the housing in the axial direction and make the wire holder move in the circumferential direction relative to the housing. With this configuration, the wire holder stably moves relative to the housing owing to the guide portion, and therefore workability is good.

In the present disclosure, the guide portion may also include a male screw portion that is formed on an outer peripheral surface of one of the housing and the wire holder and a female screw portion that is formed in an inner peripheral surface of the other of the housing and the wire holder. With this configuration, the wire holder stably moves relative to the housing as a result of the female screw portion fitting to the male screw portion, and the retwisted wires have a uniform shape.

In the present disclosure, the guide portion may also include a substantially L-shaped guide groove that is formed in a peripheral surface of one of the housing and the wire holder and a guide pin that is formed on a peripheral surface of the other of the housing and the wire holder and slides along the guide groove. With this configuration, the wire holder stably moves relative to the housing as a result of the guide pin sliding along the guide groove, and the retwisted wires have a uniform shape.

In the present disclosure, the guide portion may also include a spiral guide groove that is formed in a peripheral surface of one of the housing and the wire holder and a guide pin that is formed on a peripheral surface of the other of the housing and the wire holder and slides along the guide groove. With this configuration, the wire holder stably moves relative to the housing as a result of the guide pin sliding along the guide groove, and the retwisted wires have a uniform shape.

In the present disclosure, a magnetic core or an electromagnetic shield that surrounds retwisted regions of the wires may also be attached to at least one of the housing and the wire holder. With this configuration, good communication performance can be ensured by the magnetic core or the electromagnetic shield even if the shape of the retwisted wires differs from that before retwisting.

### Advantageous Effects of Disclosure

In a state in which the terminal fittings are inserted into the housing, untwisted regions of the wires extend to the rear side of the housing. As a result of the wire holder holding the twisted wire pair being moved close to the housing in the axial direction and moved in the circumferential direction relative to the housing, the untwisted regions of the wires are twisted and return to the twisted state.

### BRIEF DESCRIPTION OF DRAWINGS

FIG. 1 is a cross-sectional view showing a state in which untwisted regions of coated wires are retwisted in a conduction path according to Embodiment 1.

FIG. 2 is a cross-sectional view showing a state before the untwisted regions of the coated wires are retwisted.

FIG. 3 is a front view of a connector device.

FIG. 4 is a front view showing a state in which a wire holder holds a twisted wire pair.

FIG. 5 is a cross-sectional view showing a shape of protrusions of a wire holding portion.

FIG. 6 is a cross-sectional view showing another shape of protrusions of the wire holding portion.

FIG. 7 is a cross-sectional view showing another shape of protrusions of the wire holding portion.

FIG. 8 is a plan view showing a state in which untwisted regions of coated wires are retwisted in a conduction path according to Embodiment 2.

FIG. 9 is a plan view showing a state before the untwisted regions of the coated wires are retwisted.

FIG. 10 is a plan view showing a state in which untwisted regions of coated wires are retwisted in a conduction path according to Embodiment 3.

FIG. 11 is a plan view showing a state before the untwisted regions of the coated wires are retwisted.

FIG. 12 is a plan view showing a state in which terminal fittings are inserted into a housing and twisted wire pairs are held by wire holders in Embodiment 4.

FIG. 13 is a cross-sectional view showing a state in which untwisted regions of coated wires are retwisted in a conduction path according to Embodiment 5.

FIG. 14 is a plan view showing a state in which a wire holder is attached to a housing after the untwisted regions of the coated wires are retwisted.

### DETAILED DESCRIPTION OF PREFERRED EMBODIMENTS

### Embodiment 1

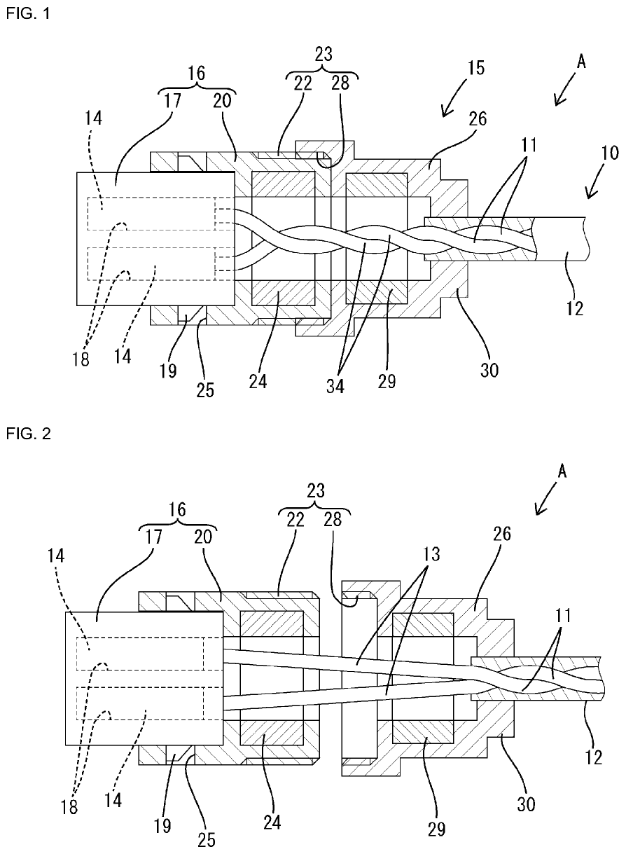

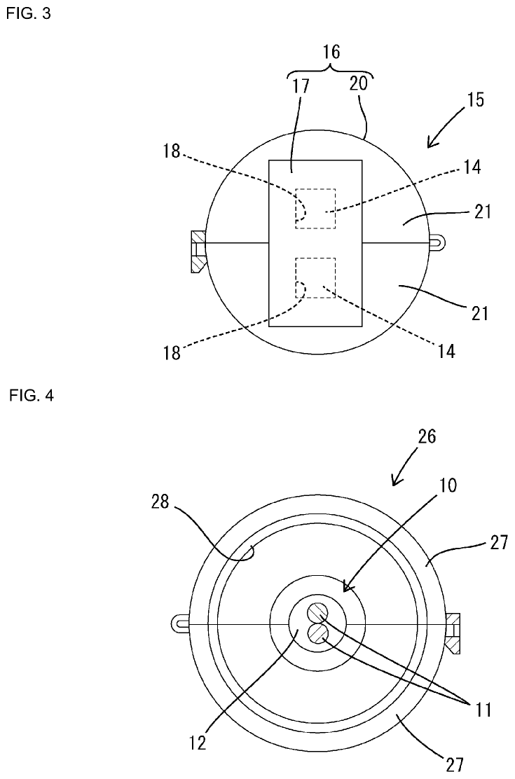

The following describes Embodiment 1, which is a specific embodiment of the present disclosure, with reference to FIGS. 1 to 7. Note that in the following description, with regard to the front-rear direction, the left side in FIGS. 1 and 2 is defined as the front side. A conduction path A according to Embodiment 1 includes a twisted wire pair 10 and a connector device 15. The twisted wire pair 10 has a known configuration that is obtained by surrounding a pair of coated wires 11 (wires referred to in the claims) with a sheath 12. Each coated wire 11 is obtained by surrounding a flexible conductor with an insulating coating that is made of a synthetic resin, and the two coated wires 11 are twisted together in a spiral form. The twisted wire pair 10 is used as a communication line in differential signal transmission.

In a front end portion of the twisted wire pair 10, the sheath 12 is removed and the two coated wires 11 are exposed in an untwisted state. Rear end portions of terminal fittings 14 are respectively fixed to front end portions of untwisted regions (hereinafter referred to as “untwisted regions 13”) of the coated wires 11 in a manner that allows for electrical conduction. The lengths of the untwisted regions 13 of the coated wires 11 are set to be longer than at least the lengths of the terminal fittings 14 in the front-rear direction.

The connector device 15 is constituted by a housing 16 and a wire holder 26. The housing 16 is formed by assembling a terminal housing member 17, a core holder 20, and a magnetic core 24. A pair of terminal housing chambers 18 are formed in the terminal housing member 17. The terminal housing chambers 18 are open at a rear end surface of the terminal housing member 17, forming terminal insertion openings. A pair of lock protrusions 19 are formed on an outer peripheral surface of the terminal housing member 17.

The core holder 20 includes a pair of housing side halved members 21 that are coupled by a hinge portion. The core holder 20 has a cylindrical shape as a whole as a result of the pair of housing side halved members 21 being combined. A male screw portion 22 is formed in a rear end portion of an outer peripheral surface of the core holder 20. The male screw portion 22 functions as a guide portion 23 when the wire holder 26 is attached to the housing 16.

The magnetic core 24 that has a cylindrical shape is attached to a front end side region of an inner peripheral surface of the core holder 20. The magnetic core 24 may be a single piece member or a member that is obtained by combining a pair of halved core components. A pair of lock holes 25 are formed in a front end portion of the core holder 20. The core holder 20 is attached to the terminal housing member 17 by fitting the pair of lock holes 25 to the pair of lock protrusions 19. The attached core holder 20 surrounds a rear end portion of the terminal housing member 17. The housing 16 is formed by attaching the core holder 20 to the terminal housing member 17.

The wire holder 26 includes a pair of wire side halved members 27 that are coupled by a hinge portion. The wire holder 26 has a cylindrical shape as a whole as a result of the pair of wire side halved members 27 being combined. A female screw portion 28 is formed in a front end portion of an inner peripheral surface of the wire holder 26. The female screw portion 28 functions as the guide portion 23 in cooperation with the male screw portion 22 when the wire holder 26 is attached to the housing 16. A magnetic core 29 is attached to a center portion in the front-rear direction of the inner peripheral surface of the wire holder 26. The magnetic core 29 may be a single piece member or a member that is obtained by combining a pair of halved core components.

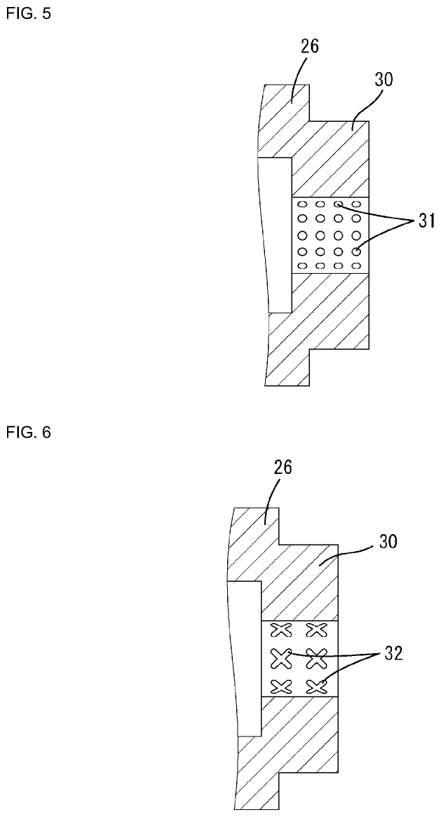

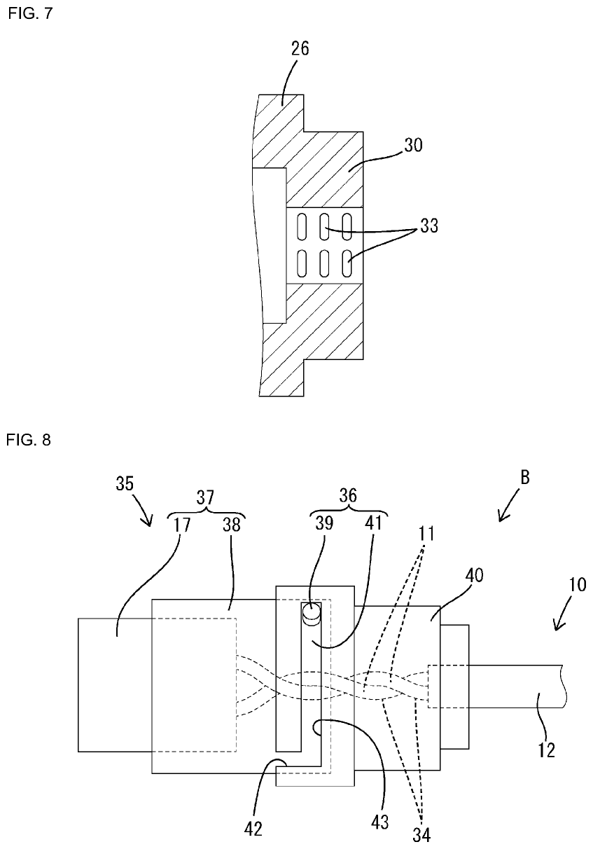

A wire holding portion 30 is formed in an inner peripheral rear end portion of the wire holder 26. Embossed protrusions 31 shown in FIG. 5, cross-shaped protrusions 32 shown in FIG. 6, rib-shaped protrusions 33 shown in FIG. 7, or the like are formed on an inner peripheral surface of the wire holding portion 30. The inner diameter of the wire holding portion 30 is set to be slightly smaller than the outer diameter of the sheath 12 of the twisted wire pair 10. The wire holding portion 30 is fitted on a front end portion of the sheath 12 of the twisted wire pair 10, and the protrusions 31, 32, or 33 bite into an outer peripheral surface of the sheath 12.

To assemble the conduction path A, first, one of the pair of terminal fittings 14 is inserted into one of the terminal housing chambers 18 from the rear side of the terminal housing member 17. Thereafter, the other terminal fitting 14 is temporarily moved to the rear side of the terminal housing member 17. At this time, the untwisted regions 13 of the coated wires 11 have lengths longer than the entire lengths of the terminal fittings 14. Therefore, the other terminal fitting 14 can be arranged directly opposite to the rear end surface of the terminal housing member 17. Accordingly, the other terminal fitting 14 can be straightly inserted into the terminal housing chamber 18 without being inclined.

When the pair of terminal fittings 14 are inserted into the terminal housing member 17, the untwisted regions 13 of the pair of coated wires 11 are led out to the rear side of the terminal housing member 17. After the terminal fittings 14 are inserted, the core holder 20 is attached to the rear end portion of the terminal housing member 17 by combining the pair of housing side halved members 21. As a result, front end side regions of the untwisted regions 13 of the two coated wires 11 are surrounded by the core holder 20, and rear end side regions of the untwisted regions 13 of the coated wires 11 are led out to the rear side of the core holder 20.

Thereafter, on the rear side of the core holder 20 (the housing 16), the wire holding portion 30 is fitted on the outer peripheral surface of the front end portion of the sheath 12 by combining the pair of wire side halved members 27, and the protrusions 31, 32, or 33 of the wire holding portion 30 bite into the outer peripheral surface of the sheath 12. Through this biting, the wire holder 26 holds a region of the twisted wire pair 10 in which the coated wires 11 embedded in the sheath 12 are twisted together. Thus, the wire holder 26 is attached to the twisted wire pair 10 such that the region of the twisted wire pair 10 held by the wire holder 26 moves together with the wire holder 26. Also, the rear end side regions of the untwisted regions 13 of the coated wires 11 lead out to the rear side of the core holder 20 are surrounded by the wire holder 26.

Thereafter, the female screw portion 28 of the wire holder 26 is screwed into the male screw portion 22 of the housing 16. As the female screw portion 28 is screwed, regions of the pair of coated wires 11 that are embedded in the sheath 12 in a twisted state come close to the terminal housing member 17 and rotate in a circumferential direction relative to the terminal housing member 17. As a result, the untwisted regions 13 of the pair of coated wires 11 are twisted between the rear end of the terminal housing member 17 and the front end of the sheath 12. When the wire holder 26 has been attached to the housing 16, the untwisted regions 13 of the pair of coated wires 11 return to the twisted state.

The conduction path A according to Embodiment 1 includes the twisted wire pair 10 obtained by twisting together the pair of coated wires 11 and the connector device 15. The pair of terminal fittings 14 are individually fixed to front end portions of the pair of coated wires 11. The connector device 15 includes the housing 16 and the wire holder 26 that is separate from the housing 16. The pair of terminal fittings 14 are inserted into the housing 16 from the rear side of the housing 16. The wire holder 26 can move close to the housing 16 in an axial direction and move in a circumferential direction relative to the housing 16 in a state in which the wire holder 26 holds the twisted wire pair 10 such that the twisted wire pair 10 can move together with the wire holder 26.

In a state in which the pair of terminal fittings 14 are inserted into the housing 16, the untwisted regions 13 of the coated wires 11 extend to the rear side of the housing 16, but there is a concern that communication performance may be deteriorated in the untwisted regions 13 due to the influence of noise. Therefore, a region of the twisted wire pair 10 in which the coated wires 11 are twisted together (i.e., a region embedded in the sheath 12) is held by the wire holder 26, and the wire holder 26 is moved close to the housing 16 in the axial direction and is moved in the circumferential direction relative to the housing 16. As a result, the untwisted regions 13 of the coated wires 11 are twisted and return to the twisted state. As a result of the untwisted regions 13 of the coated wires 11 being twisted together, good communication performance can be ensured between the rear end of the housing 16 and the front end of the sheath 12.

Furthermore, the guide portion 23 is provided in the connector device 15. The guide portion 23 makes the wire holder 26 move close to the housing 16 in the axial direction and move in the circumferential direction relative to the housing 16. The guide portion 23 includes the male screw portion 22 formed on the outer peripheral surface of the housing 16 and the female screw portion 28 formed in the inner peripheral surface of the wire holder 26. As a result of the female screw portion 28 fitting to the male screw portion 22, the wire holder 26 stably moves when the wire holder 26 is being attached to the housing 16, and therefore workability is good. Furthermore, retwisted regions 34 of the coated wires 11 that are formed by retwisting the untwisted regions 13 have a uniform shape (a uniform twist pitch).

Furthermore, the magnetic cores 24 and 29 that surround the retwisted regions 34 of the coated wires 11 are attached to the housing 16 and the wire holder 26. Therefore, even if the shape of the retwisted coated wires 11 differs from that before retwisting, good communication performance can be ensured by the magnetic cores 24 and 29.

### Embodiment 2

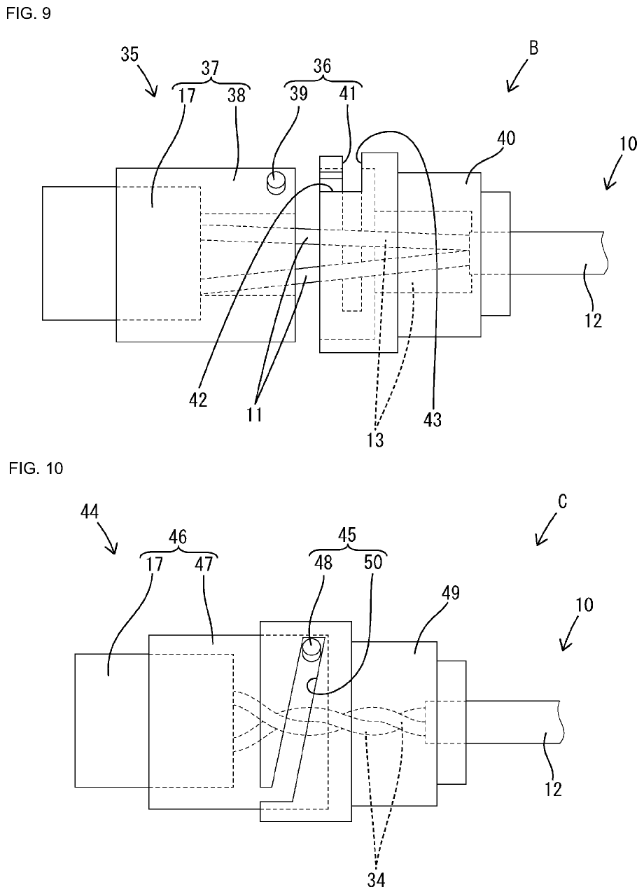

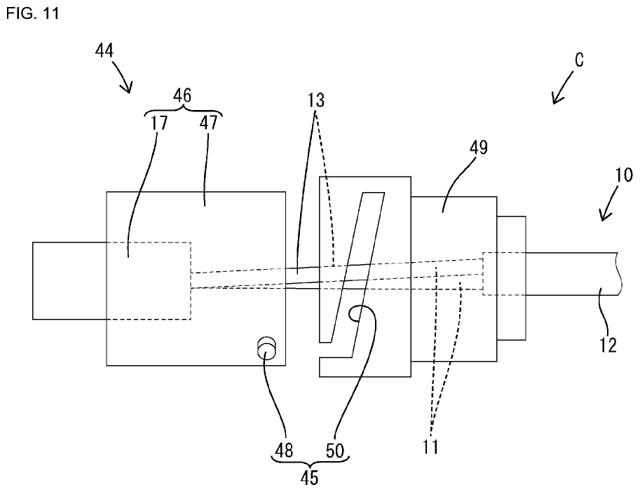

Next, Embodiment 2, which is a specific embodiment of the present disclosure, will be described with reference to FIGS. 8 and 9. A conduction path B and a connector device 35 according to Embodiment 2 differ from the above-described Embodiment 1 in the configuration of a guide portion 36. Other configurations are the same as those in the above-described Embodiment 1, and therefore the same configurations are denoted with the same reference numerals as those used in Embodiment 1, and descriptions of structures, functions, and effects of the same configurations are omitted.

The guide portion 36 in Embodiment 2 includes a guide pin 39 and a guide groove 41. The guide pin 39 is formed in a rear end portion of an outer peripheral surface of a core holder 38 out of the terminal housing member 17 and the core holder 38 that constitute a housing 37. The guide groove 41 is formed in a front end portion of a wire holder 40 and has a substantially L shape. The guide groove 41 is constituted by a first groove portion 42 that extends in the axial direction and is open at a front edge of the wire holder 40 and a second groove portion 43 that extends in the circumferential direction from a rear end of the first groove portion 42.

The wire holder 40 is fitted on a rear end portion of the housing 37 (the core holder 38) to be attached to the housing 37. To attach the wire holder 40, first, the wire holder 40 is moved close to the core holder 38 in the axial direction such that the guide pin 39 enters the first groove portion 42. Thereafter, the wire holder 40 is moved in the circumferential direction relative to the housing 37 such that the guide pin 39 moves along the second groove portion 43. As a result of the guide pin 39 sliding in contact with an inner edge portion of the guide groove 41, the wire holder 40 stably moves relative to the housing 37, and therefore workability is good. After the untwisted regions 13 of the coated wires 11 are retwisted, the retwisted regions 34 have a uniform shape.

### Embodiment 3

Next, Embodiment 3, which is a specific embodiment of the present disclosure, will be described with reference to FIGS. 10 and 11. A conduction path C and a connector device 44 according to Embodiment 3 differ from the above-described Embodiments 1 and 2 in the configuration of a guide portion 45. Other configurations are the same as those in the above-described Embodiment 1, and therefore the same configurations are denoted with the same reference numerals as those used in Embodiment 1, and descriptions of structures, functions, and effects of the same configurations are omitted.

The guide portion 45 in Embodiment 3 includes a guide pin 48 and a guide groove 50. The guide pin 48 is formed in a rear end portion of an outer peripheral surface of a core holder 47 out of the terminal housing member 17 and the core holder 47 that constitute a housing 46. The guide groove 50 is formed in a front end portion of a wire holder 49 and has a spiral shape. A front end portion of the guide groove 50 is open at a front edge of the wire holder 49. To attach the wire holder 49 to the housing 46 (the core holder 47) by fitting the wire holder 49 on a rear end portion of the housing 46 (the core holder 47), first, the wire holder 49 is moved close to the core holder 47 in the axial direction such that the guide pin 48 enters the front end portion of the guide groove 50.

Thereafter, the wire holder 49 is moved in the circumferential direction relative to the housing 46 such that the guide pin 48 moves along the groove portion 50. As a result of the guide pin 48 sliding in contact with an inner edge portion of the guide groove 50, the wire holder 49 stably moves relative to the housing 46, and therefore workability is good. Furthermore, after the untwisted regions 13 of the coated wires 11 are retwisted, the retwisted regions 34 have a uniform shape.

### Embodiment 4

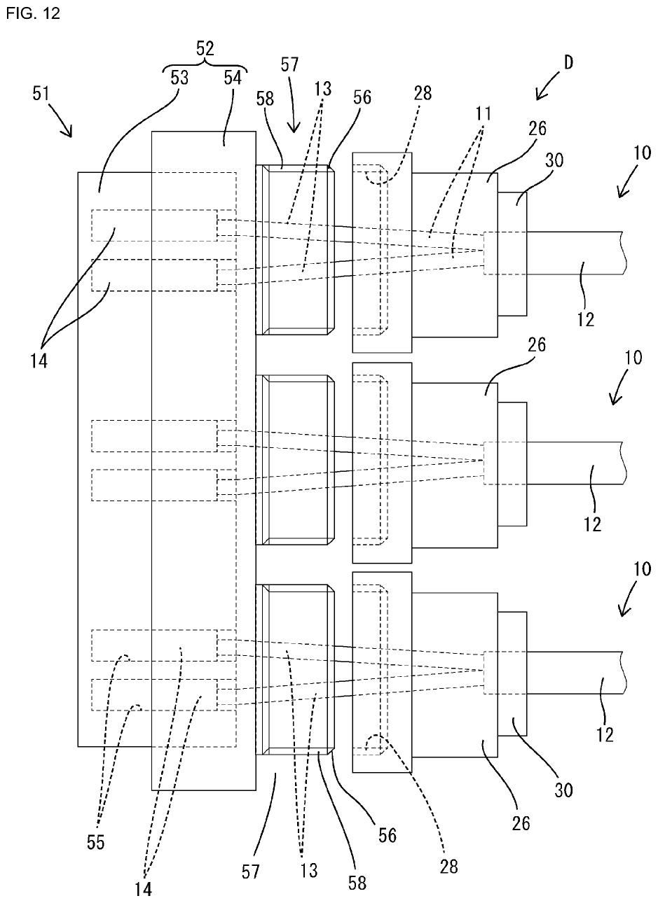

Next, Embodiment 4, which is a specific embodiment of the present disclosure, will be described with reference to FIG. 12. A conduction path D according to Embodiment 4 differs from the above-described Embodiment 1 in the number of twisted wire pairs 10 and the configuration of a connector device 51. Other configurations are the same as those in the above-described Embodiment 1, and therefore the same configurations are denoted with the same reference numerals as those used in Embodiment 1, and descriptions of structures, functions, and effects of the same configurations are omitted.

In Embodiment 4, three twisted wire pairs 10 and the single connector device 51 are provided. The connector device 51 includes a housing 52 and three wire holders 26. The housing 52 includes a terminal housing member 53 and a core holder 54. Three pairs of terminal housing chambers 55 are formed in the terminal housing member.

Three tubular attachment portions 56 that protrude from a rear end surface of the core holder 54 are formed in the core holder 54. Each tubular attachment portion 56 is formed in correspondence with a pair of terminal housing chambers 55. A magnetic core (not shown) is attached to an inner peripheral surface of each tubular attachment portion 56. A male screw portion 58 that functions as a guide portion 57 is formed on an outer peripheral surface of each tubular attachment portion 56. The wire holders 26 each have the same configuration as that in Embodiment 1.

A pair of terminal fittings 14 are individually fixed to front end portions of a pair of coated wires 11 constituting each twisted wire pair 10. Similarly to Embodiment 1, the pair of terminal fittings 14 are individually inserted into the pair of terminal housing chambers 55. After the terminal fittings 14 are inserted into the terminal housing chambers 55, the three wire holders 26 are individually attached to the sheaths 12 of the three twisted wire pairs 10. The wire holders 26 are each attached to the tubular attachment portion 56. To attach the wire holder 26, the female screw portion 28 of the wire holder 26 is screwed into the male screw portion 58 of the tubular attachment portion 56. As the female screw portion 28 is screwed, the untwisted regions 13 of the coated wires 11 of each twisted wire pair 10 are twisted. As a result of the untwisted regions 13 being twisted, the untwisted regions 13 return to the twisted state and the retwisted regions 34 are formed.

### Embodiment 5

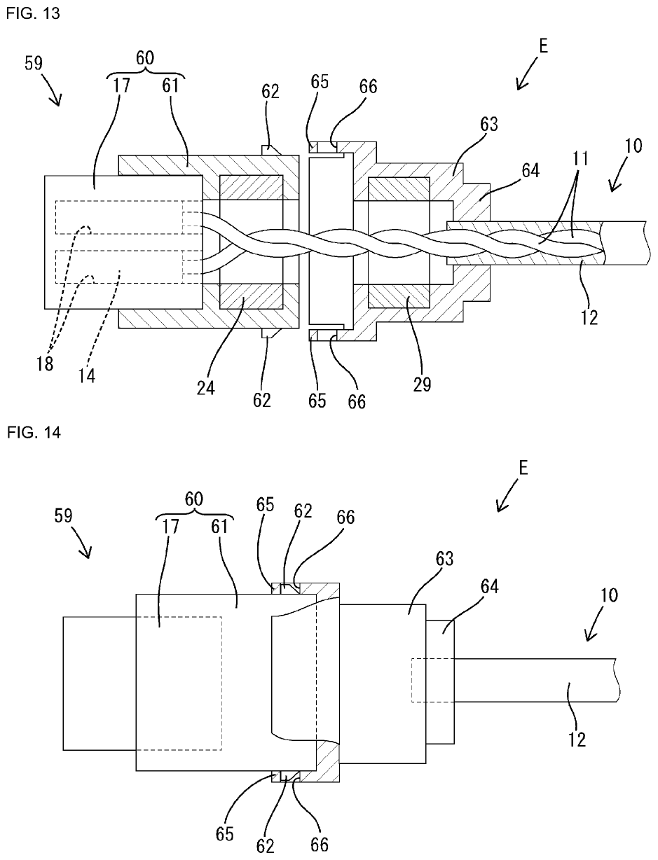

Next, Embodiment 5, which is a specific embodiment of the present disclosure, will be described with reference to FIGS. 13 and 14. A conduction path E according to Embodiment 5 differs from the above-described Embodiment 1 in the configuration of a connector device 59. Other configurations are the same as those in the above-described Embodiment 1, and therefore the same configurations are denoted with the same reference numerals as those used in Embodiment 1, and descriptions of structures, functions, and effects of the same configurations are omitted.

The connector device 59 according to Embodiment 5 is constituted by a housing 60 and a wire holder 63. The housing 60 is formed by assembling the terminal housing member 17, a core holder 61, and the magnetic core 24. The pair of terminal housing chambers 18 are formed in the terminal housing member 17. The terminal housing chambers 18 are open at the rear end surface of the terminal housing member 17, forming the terminal insertion openings.

Similarly to Embodiment 1, the core holder 61 has a cylindrical shape as a whole as a result of a pair of housing side halved members (not shown) coupled by a hinge portion (not shown) being combined. The cylindrical magnetic core 24 is attached to an inner peripheral surface of the core holder 61. A front end portion of the core holder 61 is attached to a rear end portion of the terminal housing member 17 in a state of being fitted thereon. A pair of lock protrusions 62 are formed in a rear end portion of an outer peripheral surface of the core holder 61.

Similarly to Embodiment 1, the wire holder 63 has a cylindrical shape as a whole as a result of a pair of wire side halved members (not shown) coupled by a hinge portion (not shown) being combined. Elastic lock pieces 65 are formed in a front end portion of the wire holder 63, and lock holes 66 are formed in the elastic lock pieces 65. The cylindrical magnetic core 29 is attached to a center portion in the front-rear direction of an inner peripheral surface of the wire holder 63. A wire holding portion 64 is formed in an inner peripheral rear end portion of the wire holder 63. Protrusions (not shown) like those in Embodiment 1 are formed on an inner peripheral surface of the wire holding portion 64.

To assemble the conduction path E, first, one of the pair of terminal fittings 14 is inserted into one of the terminal housing chambers 18 from the rear side of the terminal housing member 17. Thereafter, the other terminal fitting 14 is temporarily moved to the rear side of the terminal housing member 17. At this time, the other terminal fitting 14 can be arranged directly opposite to the rear end surface of the terminal housing member 17 since the untwisted regions 13 of the coated wires 11 have lengths longer than the entire lengths of the terminal fittings 14. Accordingly, the other terminal fitting 14 can be straightly inserted into the terminal housing chamber 18 without being inclined.

When the pair of terminal fittings 14 are inserted into the terminal housing member 17, the untwisted regions (not shown) of the pair of coated wires 11 are led out to the rear side of the terminal housing member 17. After the terminal fittings 14 are inserted, the core holder 61 is attached to the rear end portion of the terminal housing member 17 by combining the pair of housing side halved members. As a result, front end side regions of the untwisted regions of the two coated wires 11 are surrounded by the core holder 61. Rear end side regions of the untwisted regions of the coated wires 11 are led out to the rear side of the core holder 61.

Thereafter, on the rear side of the core holder 61 (the housing 60), the wire holding portion 64 of the wire holder 63 is fitted on the front end portion of the sheath 12, and the protrusions (not shown) bite into the outer peripheral surface of the sheath 12. Through this biting, the wire holder 63 holds a region of the twisted wire pair 10 in which the coated wires 11 embedded in the sheath 12 are twisted together. As a result, the wire holder 63 and the region of the twisted wire pair 10 held by the wire holder 63 can move together. The rear end side regions of the untwisted regions of the coated wires 11 lead out to the rear side of the core holder 61 are surrounded by the wire holder 63

Thereafter, the wire holder 63 is moved close to the housing 60 (the core holder 61) and is rotated in the circumferential direction relative to the housing 60. As a result, the untwisted regions of the pair of coated wires 11 are twisted between the rear end of the terminal housing member 17 and the front end of the sheath 12 and the pair of coated wires 11 are retwisted. After the coated wires 11 are retwisted, the wire holder 63 is attached to the outer periphery of the rear end portion of the core holder 61 without rotating the wire holder 63. At this time, the lock holes 66 are locked to the lock protrusions 62. Through this locking, the wire holder 63 and the housing 60 (the core holder 61) are locked in the attached state, and thus assembly of the connector device 59 and the conduction path E is complete.

### Other Embodiments

The present disclosure is not limited to the embodiments described above with reference to the drawings, and for example, the following embodiments are also included in the technical scope of the present disclosure.

In the above-described Embodiment 1, the male screw portion is formed in the housing and the female screw portion is formed in the wire holder, but the female screw portion may also be formed in the housing and the male screw portion may also be formed in the wire holder.

In the above-described Embodiment 2, the guide pin is formed in the housing and the guide groove is formed in the wire holder, but the guide groove may also be formed in the housing and the guide pin may also be formed in the wire holder.

In the above-described Embodiment 3, the guide pin is formed in the housing and the guide groove is formed in the wire holder, but the guide groove may also be formed in the housing and the guide pin may also be formed in the wire holder.

In the above-described Embodiments 1 to 5, the housing is formed by attaching the core holder to the terminal housing member, but the housing may also be a single piece member that is obtained by forming the terminal housing member and the core holder as a single piece.

In the above-described Embodiments 1 to 5, the magnetic cores are attached to both of the housing and the wire holder, but a configuration is also possible in which a magnetic core is only attached to the housing or the wire holder.

In the above-described Embodiments 1 to 5, the retwisted regions of the wires are surrounded by the magnetic cores, but a configuration is also possible in which the magnetic cores are not provided.

In the above-described Embodiments 1 to 5, the retwisted regions of the wires are surrounded by the magnetic cores, but the retwisted regions of the wires may also be surrounded by an electromagnetic shield instead of the magnetic cores.

In the above-described Embodiment 4, the housing is formed by attaching the single core holder to the single terminal housing member, but the housing may also be formed by attaching a plurality of core holders to the single terminal housing member or attaching the single core holder to a plurality of terminal housing members.

In the above-described Embodiment 4, the three wire holders (the three twisted wire pairs) are attached to the single housing, but the number of wire holders (the number of twisted wire pairs) attached to the single housing may also be two or four or more.

1. A conduction path comprising:
a housing;
a twisted wire pair that is obtained by twisting together a pair of wires;
a pair of terminal fittings that are individually fixed to front end portions of the pair of wires and are inserted into the housing from behind; and
a wire holder that is separate from the housing and holds the twisted wire pair such that the twisted wire pair can move together with the wire holder,
wherein the wire holder can move close to the housing in an axial direction and move in a circumferential direction relative to the housing.

2. The conduction path according to claim 1, further comprising:
a guide portion that is configured to make the wire holder move close to the housing in the axial direction and make the wire holder move in the circumferential direction relative to the housing.

3. The conduction path according to claim 2,
wherein the guide portion includes:
a male screw portion that is formed on an outer peripheral surface of one of the housing and the wire holder; and
a female screw portion that is formed in an inner peripheral surface of the other of the housing and the wire holder.

4. The conduction path according to claim 2,
wherein the guide portion includes:
a substantially L-shaped guide groove that is formed in a peripheral surface of one of the housing and the wire holder; and
a guide pin that is formed on a peripheral surface of the other of the housing and the wire holder and slides along the guide groove.

5. The conduction path according to claim 2,
wherein the guide portion includes:
a spiral guide groove that is formed in a peripheral surface of one of the housing and the wire holder; and
a guide pin that is formed on a peripheral surface of the other of the housing and the wire holder and slides along the guide groove.

6. The conduction path according to claim 1, wherein a magnetic core or an electromagnetic shield that surrounds retwisted regions of the wires is attached to at least one of the housing and the wire holder.

7. A connector device comprising:
a housing;
a pair of terminal fittings that are configured to be individually fixed to front end portions of a pair of wires constituting a twisted wire pair and are inserted into the housing from behind; and
a wire holder that is separate from the housing and is configured to hold the twisted wire pair such that the twisted wire pair can move together with the wire holder,
wherein the wire holder can move close to the housing in an axial direction and move in a circumferential direction relative to the housing.

8. The conduction path according to claim 2, wherein a magnetic core or an electromagnetic shield that surrounds retwisted regions of the wires is attached to at least one of the housing and the wire holder.

9. The conduction path according to claim 3, wherein a magnetic core or an electromagnetic shield that surrounds retwisted regions of the wires is attached to at least one of the housing and the wire holder.

10. The conduction path according to claim 4, wherein a magnetic core or an electromagnetic shield that surrounds retwisted regions of the wires is attached to at least one of the housing and the wire holder.

11. The conduction path according to claim 5, wherein a magnetic core or an electromagnetic shield that surrounds retwisted regions of the wires is attached to at least one of the housing and the wire holder.
